(19) United States
(12) Patent Application Publication
(10) Pub. No.: US 2024/0418866 A1
(43) Pub. Date: Dec. 19, 2024

(54) GLOBAL NAVIGATION SATELLITE SYSTEM (GNSS) TIME SYNCHRONIZATION FOR GATEWAY DEVICES

(71) Applicant: Oxit, LLC, Charlotte, NC (US)

(72) Inventors: Peter O'Connor, Charlotte, NC (US); Shobhit Aggarwal, Charlotte, NC (US); Josh Cox, Charlotte, NC (US)

(21) Appl. No.: 18/741,669

(22) Filed: Jun. 12, 2024

Related U.S. Application Data
(60) Provisional application No. 63/508,828, filed on Jun. 16, 2023.

(51) Int. Cl. G01S 19/24; G01S 19/03

(52) U.S. Cl. CPC G01S 19/243; G01S 19/03

(57) ABSTRACT

System, devices, and methods for facilitating time synchronization of gateway devices are disclosed. A relay device can generate, via a Global Navigation Satellite System (GNSS) component, a plurality of pulse per second (PPS) signals based on establishing a connection with at least one GNSS satellite. The plurality of PPS signals are time synchronized with a GNSS clock. The relay device can determine a first PPS signal of the plurality of PPS signals associated with the at least one gateway device sending a beacon to at least one end device. Based on the determined first PPS signal, the relay device can determine a second PPS signal of the plurality of PPS signals associated with sending a message to the at least one gateway device. The relay device can send the message to the at least one gateway device based on detecting an edge of the second PPS signal.

### CROSS-REFERENCE TO RELATED APPLICATION

This application claims priority to U.S. Provisional Patent Application No. 63/508,828, filed Jun. 16, 2023, which is hereby incorporated by reference in its entirety.

### BACKGROUND

Some end devices can rely on receiving time-synchronized beacons from a gateway device to sync (e.g., align) the internal clock of the end device with the network. However, a gateway device may be unable to send time-synchronized beacons to end devices if the gateway device is not properly synced with the Global Navigation Satellite System (GNSS) clock. The gateway device may not be properly synced with the GNSS clock if the gateway device is unable to receive a GNSS signal. Therefore, improvements in GNSS time synchronization techniques for gateway devices are desirable.

### SUMMARY

The disclosed embodiments provide for a system for GNSS time synchronization. The system comprises at least one gateway device and a relay device. The relay device is in communication with the at least one gateway device. The relay device is configured to generate, via a Global Navigation Satellite System (GNSS) component, a plurality of pulse per second (PPS) signals based on establishing a connection with at least one GNSS satellite. The plurality of PPS signals is time synchronized with a GNSS clock. The relay device is configured to determine a first PPS signal of the plurality of PPS signals associated with the at least one gateway device sending a beacon to at least one end device. The relay device is configured to determine a second PPS signal of the plurality of PPS signals associated with sending a message to the at least one gateway device based on the determined first PPS signal. The second PPS signal occurs before the first PPS signal. The relay device is configured to send the message to the at least one gateway device based on detecting an edge (e.g., positive edge or negative edge) of the second PPS signal. The at least one gateway device is configured to utilize a time associated with receipt of the message at the at least one gateway device to determine that the at least one gateway device is time synchronized with the GNSS clock.

In some embodiments, a relay device is disclosed. The relay device includes a GNSS component. The GNSS component is configured to generate a plurality of pulse per second (PPS) signals based on establishing a connection with at least one GNSS satellite. The plurality of PPS signals is time synchronized with a GNSS clock. The relay device includes one or more processors and memory storing instructions that, when executed by the one or more processors, cause the device to determine a first PPS signal of the plurality of PPS signals associated with the at least one gateway device sending a beacon to at least one end device. The relay device is configured to determine a second PPS signal of the plurality of PPS signals associated with sending a message to the at least one gateway device based on the determined first PPS signal. The second PPS signal occurs before the first PPS signal. The relay device is configured to send the message to the at least one gateway device based on detecting an edge (e.g., positive edge or negative edge) of the second PPS signal. The at least one gateway device is configured to utilize a time associated with receipt of the message at the at least one gateway device to determine that the at least one gateway device is time synchronized with the GNSS clock.

In some embodiments, a method is disclosed. The method includes generating, via a Global Navigation Satellite System (GNSS) component, a plurality of pulse per second (PPS) signals based on establishing a connection with at least one GNSS satellite. The plurality of PPS signals is time synchronized with a GNSS clock. The method includes determining a first PPS signal of the plurality of PPS signals associated with the at least one gateway device sending a beacon to at least one end device. The method includes determining a second PPS signal of the plurality of PPS signals associated with sending a message to the at least one gateway device based on the determined first PPS signal. The second PPS signal occurs before the first PPS signal. The method includes sending the message to the at least one gateway device based on detecting an edge (e.g., positive edge or negative edge) of the second PPS signal. The at least one gateway device is configured to utilize a time associated with receipt of the message at the at least one gateway device to determine that the at least one gateway device is time synchronized with the GNSS clock.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

Additional advantages will be set forth in part in the description which follows or may be learned by practice. It is to be understood that both the foregoing general description and the following detailed description are exemplary and explanatory only and are not restrictive.

### BRIEF DESCRIPTION OF THE DRAWINGS

The accompanying drawings, which are incorporated in and constitute a part of this specification, illustrate embodiments and together with the description, serve to explain the principles of the methods and systems.

FIG. 1 is an example network.

FIG. 2 is an example system.

FIG. 3 is an example system for generating a pulse-per-second (PPS) signal.

FIG. 4 is an example process.

FIG. 5 is an example method.

FIG. 6 is an example method.

FIG. 7 is an example computing device.

### DETAILED DESCRIPTION OF ILLUSTRATIVE EMBODIMENTS

Systems, devices, and methods for facilitating Global Navigation Satellite System (GNSS) time synchronization of gateway devices are disclosed. As described above, some end devices can rely on receiving time-synchronized beacons from a gateway device to sync (e.g., align) the internal clock of the end device with the network, such as Class B communication with end devices for Long Range Wide Area Network (LoRaWAN). However, a gateway device may be unable to send time-synchronized beacons to end devices if the gateway device is not properly synced with the GNSS clock. The gateway device may not be properly synced with the GNSS clock if the gateway device is unable to receive a GNSS signal. The gateway device may be unable to receive a GNSS signal, for example, if the gateway device is located indoors where GNSS signal is not reachable.

The time synchronization of gateway devices that are unable to receive a GNSS signal can be facilitated by the gateway device estimating time and inferring GNSS time synchronization based on a server Round-Trip Time associated with a time sync uplink message and a pulse per second (PPS) signal that is not necessarily aligned with GNSS time. However, for this time synchronization technique to be successful, the gateway device needs to have a very accurate source for the PPS signal. For this time synchronization technique to be successful, the gateway device further needs to be able to establish and/or maintain a low latency (e.g., less than 150 ms) Internet connection to provide consistent functionality to support communication that requires strict time synchronization. The gateway device may not always be able to establish and/or maintain such a low-latency network connection. Thus, improved techniques for facilitating time synchronization of gateway devices are needed.

Described herein are improved techniques for facilitating GNSS time synchronization of gateway devices. The techniques described herein facilitate GNSS time synchronization of a gateway device even if the gateway device is unable to receive a GNSS signal. A gateway device, which may or may not be able to receive a GNSS signal, can communicate with a relay device. The relay device is able to receive a GNSS signal and can thus synchronize its internal clock with the GNSS clock. The relay device can send a synchronization message to the gateway device. The gateway device can utilize the receive time of the synchronization message to determine whether the gateway device is time-synchronized with the GNSS clock. If the gateway device determines it is time-synchronized with the GNSS clock, the gateway device can issue a time-synchronized beacon to one or more end devices.

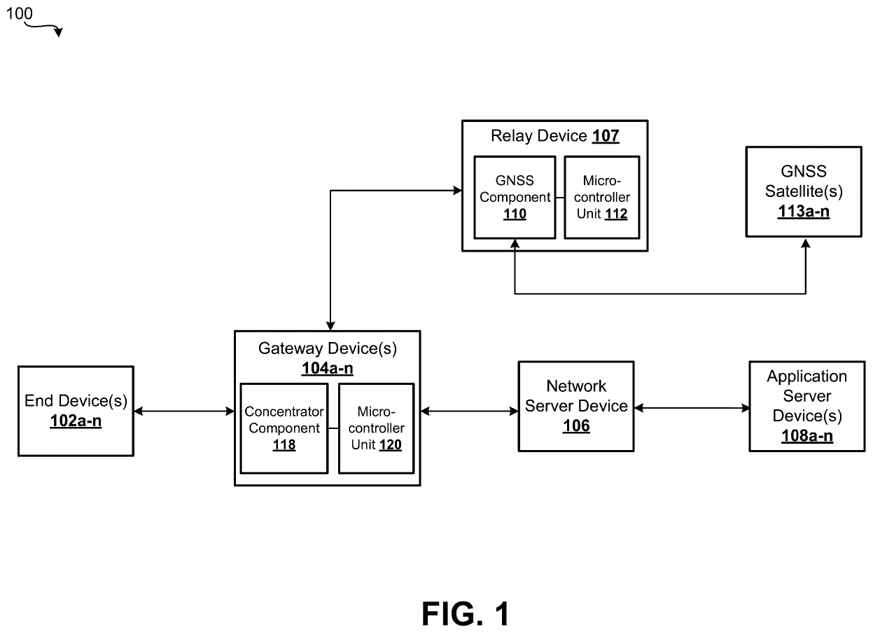

FIG. 1 shows a block diagram of an example network 100. The network 100 can, for example, comprise a LoRaWAN network, a wired Ethernet network, a Wi-Fi network, a cellular network, and/or any other type of network. The network 100 comprises one or more end devices 102a-n, one or more gateway devices 104a-n, a relay device 107, one or more GNSS satellites 113a-n, a network server 106, and one or more application servers 108a-n. The end device(s) 102a-n can be wirelessly connected to the gateway device(s) 104a-n. The gateway device(s) 104a-n can be wirelessly connected to the relay device 107 and the network server 106. The network server 106 can be wirelessly connected to the application server(s) 108a-n.

The end device(s) 102a-n can comprise one or more sensors. The one or more sensors can include one or more temperature sensors. The one or more sensors can include one or more pressure sensors. The one or more sensors can include motion sensors. The one or more sensors can include image sensors. The one or more sensors can include proximity sensors. The one or more sensors can include water quality sensors. The one or more sensors can include chemical sensors. The one or more sensors can include gas sensors. The one or more sensors can include smoke sensors. The one or more sensors can include infrared (IR) sensors. The one or more sensors can include any other type of sensor.

The gateway device(s) 104a-n may be in communication with the end device(s) 102a-n. The gateway device(s) 104a-n can comprise one or more LoRaWAN gateway devices. The LoRaWAN gateway device can be configured to support Class B end devices (e.g., end devices operating in a Class B mode of communication). In embodiments, the gateway device(s) 104a-n comprise a concentrator component 118. The concentrator component 118 is configured to receive and/or transmit data packets from and to the end devices(s) 102a-n. The concentrator component 118 can receive multiple signals to serve a large number of end devices(s) 102a-n. In embodiments, the gateway device(s) 104a-n comprise a processing component, such as a microcontroller unit 120.

The end device(s) 102a-n comprise Class B end devices. If the end device(s) 102a-n are Class B end devices, the network server 106 can send downlink messages to the end device(s) 102a-n at preconfigured times. The end device(s) 102a-n do not need to send an uplink message to the network server 106 to be able to receive a downlink message from the network server 106. If the end device(s) 102a-n are configured to operate in Class B communication mode, the end device(s) 102a-n can receive downlink messages from the network server 106 during receive windows (e.g., ping slots). The end device(s) 102a-n can open the receive windows based on (e.g., in response to) receiving time-synchronized beacons transmitted by the gateway device(s) 104a-n. In particular, the time-synchronized beacons transmitted by the gateway device(s) 104a-n can provide a timing reference for the internal clocks of the end device(s) 102a-n. The end device(s) 102a-n can then use this timing reference to schedule the opening of receive windows for receiving potential downlink messages from the network server 106. The end device(s) 102a-n can also open receive windows after sending an uplink message to the network server 106 via the gateway device(s) 104a-n.

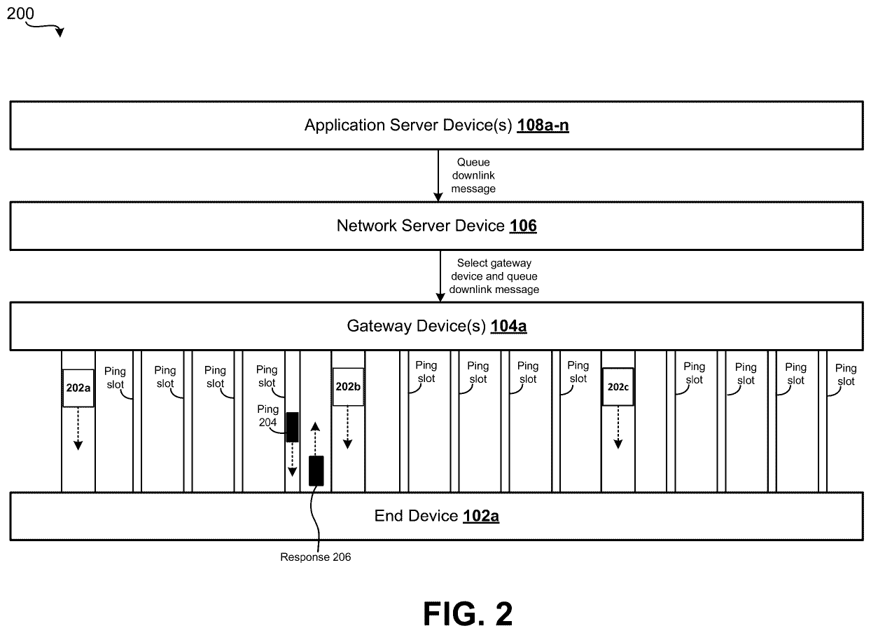

FIG. 2 shows an example system 200 for transmission of a downlink message to an end device operating in Class B communication mode.

The gateway device 104a transmits time-synchronized beacons to the end device 102a. The gateway device 104a transmits a time-synchronized beacon, for example, every 128 seconds. For example, the gateway device 104a can transmit a first time-synchronized beacon 202a to the end device 102a. 128-seconds after transmitting the first time-synchronized beacon 202a to the end device 102a, the gateway device 104a can transmit a second time-synchronized beacon 202b to the end device 102a. 128-seconds after transmitting the second time-synchronized beacon 202b to the end device 102a, the gateway device 104a can transmit a third time-synchronized beacon 202c to the end device 102a, and so on. The time-synchronized beacons transmitted by the gateway device 104a may be used by the end device 102a to provide a timing reference for the internal clocks of the end device 102a. The end device 102a can then use this timing reference to schedule the opening of receive windows (e.g., ping slots) for receiving potential downlink messages from the network server 106.

The application server(s) 108a-n can perform uplink data decryption and decoding. The application server(s) 108a-n can additionally perform downlink message queuing and downlink data encoding and encryption. The application server(s) 108a-n can queue a downlink message to be sent to an end device (e.g., the end device 102a) into the network server 106. The network server 106 can determine the next receive window schedule. The network server 106 can select a gateway (e.g., the gateway 104a) for transmitting the downlink message to the end device 102a. The network server 106 can select the gateway 104a based on the last uplink message received from the end device 102a. The network server 106 can select the gateway 104a based on the transmission schedule of the gateway 104a.

The network server 106 can queue the downlink message into the gateway 104a. When the start time of a selected receive window occurs, the gateway 104a transmits the downlink message (e.g., ping 204) to the end device 102a during the selected receive window. The end device 102a can receive the downlink message from the gateway 104a. In response to receiving the downlink message from the gateway 104a, the end device 102 can send a response 206 to the network server 106.

Thus, to support Class B communication mode, the gateway device 104a must be able to broadcast the time-synchronized beacons (e.g., the beacons 202a-c) that provide a timing reference for the internal clocks of the end device 102a. Without the timing reference provided by the time-synchronized beacons, the end device 102a is unable to schedule when receive windows are opened to receive potential downlink messages from the network server 106.

However, as described above, a gateway device, such as the gateway device 104a, may be unable to broadcast time-synchronized beacons to end devices, such as the end device 102a, if the gateway device is not properly synced with the GNSS clock. The gateway device may not be properly synced with the GNSS clock if the gateway device is unable to receive a GNSS signal. The gateway device may be unable to receive a GNSS signal, for example, if the gateway device is in a location where GNSS signal is not reachable, such as indoors.

Referring back to FIG. 1, the relay device 107 can facilitate GNSS time synchronization of the gateway device(s) 104a-n even if the gateway device(s) 104a-n are unable to receive a GNSS signal. In embodiments, the relay device 107 includes a GNSS component 110. In embodiments, the relay device 107 includes a processing component, such as a microcontroller unit (MCU) 112.

The relay device 107 can associate itself with the network 100. In embodiments, the relay device 107 can associate itself with the network 100 using Over-The-Air Activation (OTAA). If the relay device 107 is in OTAA mode, the relay device 107 can automatically attempt to associate itself with the network 100 based on (e.g., in response to) being powered on. To associate itself with the network 100 using OTAA, the relay device 107 can send a join message to the network server 106. The join message indicates that the relay device 107 wants to join the network 100. The join message can indicate a key. The network server 106 can verify that the key indicated by the join message corresponds to (e.g., matches) a key stored at the network server 106. If the join message key corresponds to the key stored at the network server 106, the network server 106 allows the relay device 107 to join the network 100 and communicate with other devices on the network 1000. In other embodiments, the relay device 107 can associate itself with the network 100 without joining the network 100. For example, if the relay device 107 already knows the session context, the relay device 107 can be assigned to the network 100.

In embodiments, the GNSS component 110 attempts to acquire a GNSS lock. The GNSS component 110 can attempt to acquire the GNSS lock based on (e.g., in response to) determining that the relay device 107 has associated itself with the network 100. The GNSS component 110 can attempt to acquire a GNSS lock by attempting to initiate a connection with the GNSS satellite(s) 113a-n. The GNSS component 110 can automatically attempt to acquire a GNSS lock based on (e.g., in response to) being turned on (e.g., powered on). If the GNSS component 110 successfully acquires a GNSS lock, the GNSS component 110 can begin generating a plurality of PPS signals. The plurality of PPS signals is time synchronized with the GNSS clock. The GNSS component 110 can send an indication of a current time associated with the GNSS clock to the MCU 112.

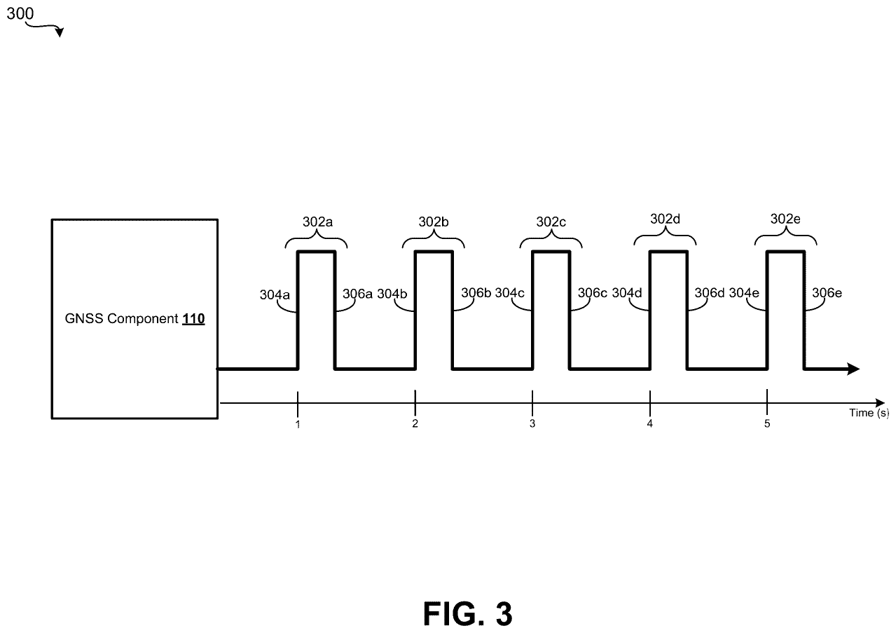

FIG. 3 is an example system 300 for generating a plurality of PPS signals. The GNSS component 110 is generating the plurality of PPS signals 302a-e. The GNSS component 110 may have begun generating the plurality of PPS signals 302a-e based on (e.g., in response to) the GNSS component 110 successfully acquiring a GNSS lock. The plurality of PPS signals 302a-e is time synchronized with the GNSS clock. The plurality of PPS signals 302a-e is receivable (e.g., detectable) by the MCU 112.

The plurality of PPS signals 302a-e comprises a plurality of positive edges 304a-c. For example, the PPS signal 302a comprises the positive edge 304a, the PPS signal 302b comprises the positive edge 304b, the PPS signal 302c comprises the positive edge 304c, the PPS signal 302d comprises the positive edge 304d, the PPS signal 302e comprises the positive edge 304c, and so on. A positive edge occurs every one second. For example, the first positive edge 304a occurs at t=1 second, the second positive edge 304b occurs at t=2 seconds, the third positive edge 304c occurs at t=3 seconds, the fourth positive edge 304d occurs at t=4 seconds, the fifth positive edge 304c occurs at t=5 seconds and so on. The plurality of PPS signals 302a-e comprises a plurality of negative edges 306a-e. For example, the PPS signal 302a comprises the negative edge 306a, the PPS signal 302b comprises the negative edge 306b, the PPS signal 302c comprises the negative edge 306c, the PPS signal 302d comprises the negative edge 306d, the PPS signal 302e comprises the negative edge 306e, and so on. A negative edge occurs every one second.

Referring back to FIG. 1, in embodiments, the MCU 112 receives the indication of the current time associated with the GNSS clock from the GNSS component 110. The MCU 112 can determine a beacon send time at which the gateway device(s) 104a-n are next scheduled to send a beacon to the end device(s) 102a-n. As described above, the gateway device(s) 104a-n can transmit a time-synchronized beacon every 128 seconds. The MCU 112 can determine a first PPS signal of the plurality of PPS signals. The first PPS signal can be associated with the at least one gateway device sending a next beacon to the end device(s) 102a-n. For example, the at least one gateway device may be scheduled to send the next beacon to the end device(s) 102a-n at an edge (e.g., positive edge or negative edge) of the first PPS signal. The MCU 112 can determine the first PPS signal by determining a quantity (“K”) of PPS signals of the plurality of PPS signals that are to occur in between the current time associated with the GNSS clock and the beacon send time. For example, the MCU 112 can determine the first PPS signal by determining the quantity K of PPS signals that are to occur in between the PPS signal associated with the current time and the beacon send time.

Referring to the example of FIG. 3, the current time associated with the GNSS clock can be associated with or aligned with the positive edge 304a of the PPS signal 302a. The MCU 112 can determine that the beacon send time is four seconds after the current time associated with the GNSS clock. If the beacon send time is four seconds after the current time associated with the GNSS clock, four PPS signals will occur in between the current time associated with the GNSS clock and the beacon send time (e.g., K is equal to four). If the current time associated with the GNSS clock is associated with or aligned with the positive edge 304a of the PPS signal 302a, the MCU 112 can determine that the beacon send time is to occur at the positive edge 304e of the PPS signal 302e, as the positive edge 304e of the PPS signal 302e will occur four seconds after the positive edge 304a of the PPS signal 302a. Thus, the MCU 112 can determine that the first PPS signal is the PPS signal 302c.

In embodiments, the MCU 112 determines a second PPS signal of the plurality of PPS signals. The second PPS signal is associated with sending a message to the at least one gateway device. The MCU 112 can determine the second PPS signal based on the determined first PPS signal. The second PPS signal occurs before the first PPS signal. The MCU 112 can determine the second PPS signal associated with sending the message to the at least one gateway device by determining that an edge (e.g., positive edge or negative edge) of the second PPS signal occurs a first predetermined amount of time before the edge of the first PPS signal at which the gateway device is scheduled to send the next beacon to the end device(s) 102a-n. The first predetermined amount of time can be, for example, one second, two seconds, three seconds, four seconds, or any other number of seconds or milliseconds.

Referring back to the example of FIG. 3, if the first PPS signal is the PPS signal 302e, the MCU 112 can determine the second PPS signal based on the PPS signal 302e. For example, the MCU 112 can determine that the second PPS signal is the PPS signal of the plurality of PPS signals that occurs the first predetermined amount of time before the positive edge 304e of the first PPS signal 302e. If the first predetermined amount of time is two seconds, the MCU 112 can determine that the second PPS signal is the PPS signal 302c, as the positive edge 304c of the PPS signal 302c occurs two seconds before the positive edge 304e of the first PPS signal 302c.

In embodiments, the MCU 112 determines a third PPS signal of the plurality of PPS signals. The third PPS signal is associated with preparing the message. The MCU 112 can determine the third PPS signal based on the determined second PPS signal. The third PPS signal occurs before the second PPS signal. The MCU 112 can determine the third PPS signal associated with preparing the message by determining that an edge (e.g., positive edge or negative edge) of the third PPS signal occurs a second predetermined amount of time before the edge of second PPS signal at which the MCU 112 needs to send the message to the at least one gateway device. The second predetermined amount of time can be, for example, one second, two seconds, three seconds, four seconds, or any other number of seconds or milliseconds. The second predetermined amount of time before the edge of the second PPS signal can comprise a sufficient amount of time to prepare the message before the message needs to be sent at the edge of the second PPS signal.

Referring back to the example of FIG. 3, if the first PPS signal is the PPS signal 302c and the second PPS signal is the PPS signal 302c, the MCU 112 can determine the third PPS signal based on the PPS signal 302c. For example, the MCU 112 can determine that the third PPS signal is the PPS signal of the plurality of PPS signals that occurs the second predetermined amount of time before the positive edge 304c of the second PPS signal 302c. If the second predetermined amount of time is one second, the MCU 112 can determine that the third PPS signal is the PPS signal 302b, as the positive edge 304b of the PPS signal 302b occurs one second before the positive edge 304c of the second PPS signal 302c.

In embodiments, the MCU 112 prepares the message. The MCU 112 can prepare the message based on detecting the edge (e.g., positive edge or negative edge) of the third PPS signal. For example, the MCU 112 can prepare the message based on detecting the positive edge 304 of the PPS signal 302b The message can comprise an encrypted SYNC message. The message comprises data indicating that the message is a SYNC message. For example, the message can include data identifying the message as a proprietary SYNC message. The message can further include data indicating how the transmission time-on-air expectation changes for a particular uplink data rate. The message can further comprise a device identifier associated with the relay device 107. The message can further comprise dummy data (e.g., some unique sequence of bits). The message can further comprise data indicating the GNSS position (e.g., latitude, longitude) data of the relay device 107.

In other embodiments, the MCU 112 can prepare the message based on detecting a positive edge of the second PPS signal. Referring back to the example of FIG. 3, if the second PPS signal is the PPS signal 302c, the MCU 112 can prepare the message based on detecting the positive edge 304c of the PPS signal 302c.

The MCU 112 is configured to send the message to the gateway device(s) 104a-n. The MCU 112 can send the message based on detecting the edge (e.g., positive edge or negative edge) of the second PPS signal. If the MCU 112 prepared the message based on detecting the positive edge of the second PPS signal, the MCU 112 can send the message to the gateway device(s) 104a-n based on detecting a negative edge of the second PPS signal. Referring back to the example of FIG. 3, if the second PPS signal is the PPS signal 302c, the MCU 112 can send the message based on detecting the negative edge 306c of the PPS signal 302c. If the MCU 112 prepared the message based on detecting the edge (e.g., positive edge or negative edge) of the third PPS signal, the MCU 112 can send the message based on detecting the positive edge of the second PPS signal. Referring back to the example of FIG. 3, if the second PPS signal is the PPS signal 302c, the MCU 112 can send the message based on detecting the positive edge 304c of the PPS signal 302c.

In embodiments, the MCU 112 can send the message to the gateway device(s) 104a-n based on (e.g., in response to) determining that the second predetermined amount of time has elapsed since initiating preparation of the message. For example, the MCU 112 can utilize a timer to determine when to send the message to the gateway device(s) 104a-n. The MCU 112 may start (e.g., initiate) a timer based on (e.g., in response to) initiating preparation of the message. The timer can be configured to expire in response to the second predetermined amount of time elapsing. The MCU 112 can send the message to the gateway device(s) 104a-n in response to determining that the timer is expired. In embodiments, an interrupt handler forces the MCU 112 to send the message to the gateway device(s) 104a-n based on (e.g., in response to) determining that the first timer is expired. The MCU 112 can send the message to the gateway device(s) 104a-n using a user selected uplink Port.

The gateway device(s) 104a-n can receive the message. In embodiments, gateway device(s) 104a-n can receive the message via the concentrator component 118. As described above, the message can comprise data identifying the message as a proprietary SYNC message. The message can further comprise the time in seconds in which the message was sent and/or any other proprietary data. In response to receiving the message, the gateway device(s) 104a-n (e.g., the concentrator component 118) can determine that the message is a SYNC message based on the data included in the message.

It can take the message a predetermined amount of send time to reach the gateway device(s) 104a-n. The predetermined amount of send time can comprise any number of seconds or milliseconds, such as 200 milliseconds, 300 milliseconds, 400 milliseconds, 500 milliseconds, 600 milliseconds, 700 milliseconds, 800 milliseconds, 900 milliseconds, one second, etc. Thus, while the message was sent by the relay device 107 the first predetermined amount of time (e.g., two seconds) before the beacon send time, the message may not be received by the gateway device(s) 104a-n the first predetermined amount of time before the beacon send time. For example, if the first predetermined amount of time is two seconds, and the predetermined amount of send time is 500 milliseconds, the message can be received by the gateway device(s) 104a-n 1.5 seconds before the beacon send time. The predetermined amount of send time is known to the gateway device(s) 104a-n.

In embodiments, the gateway device(s) 104a-n (e.g., the concentrator component 118) can determine a time associated with receipt of the message. The gateway device(s) 104a-n (e.g., the concentrator component 118) can determine the time associated with receipt of the message based on the internal microsecond count of the concentrator component 118. The time can be the time at which the gateway device(s) 104a-n (e.g., the concentrator component 118) received the message. The gateway device(s) 104a-n can, for example, create a timestamp associated with the message. The timestamp can indicate the time at which the gateway device(s) 104a-n (e.g., the concentrator component 118) received the message. The gateway device(s) 104a-n (e.g., the concentrator component 118) can send the timestamp to the MCU 120.

In embodiments, the gateway device(s) 104a-n (e.g., the MCU 120) can authenticate the message. The gateway device(s) 104a-n (e.g., the MCU 120) can authenticate the message based on (e.g., in response to) determining that the message is a SYNC message. The gateway device(s) 104a-n can authenticate the message to verify that the message was received from the relay device 107. In embodiments, to authenticate the message, the gateway device(s) 104a-n can verify that the message was received via the user selected uplink Port. To authenticate the message, the gateway device(s) 104a-n can parse the message with a known encryption key. If the gateway device(s) 104a-n (e.g., the MCU 120) determine that the decrypted payload matches what is expected from the relay device 107, the message is authenticated.

In embodiments, the gateway device(s) 104a-n (e.g., the MCU 120) receive the timestamp. The gateway device(s) 104a-n (e.g., the MCU 120) can synchronize a clock (e.g., an internal clock) of the gateway device(s) 104a-n with the GNSS clock. The gateway device(s) 104a-n (e.g., the MCU 120) can synchronize the clock of the gateway device(s) 104a-n with the GNSS clock based on the timestamp. For example, the gateway device(s) 104a-n (e.g., the MCU 120) can determine (e.g., estimate) when the edge of the second PPS signal at which the message was sent occurred.

As described above, the predetermined amount of send time is known to the gateway device(s) 104a-n. Thus, the gateway device(s) 104a-n (e.g., the MCU 120) can use the timestamp and the predetermined amount of send time to determine (e.g., estimate) when the edge of the second PPS signal occurred. For example, if the predetermined amount of send time is 500 milliseconds, the gateway device(s) 104a-n (e.g., the MCU 120) can determine that the edge of the second PPS signal occurred 500 milliseconds before the message receipt time indicated by the timestamp. The gateway device(s) 104a-n (e.g., the MCU 120) can synchronize the internal clock of the gateway device(s) 104a-n with the GNSS clock by determining and applying an offset to its internal clock based on the time difference between its internal clock and the estimated time of occurrence of the edge of the second PPS signal. Based on synchronizing the clock of the gateway device(s) 104a-n with the GNSS clock, the gateway device(s) 104a-n (e.g., the MCU 120) can determine that the gateway device(s) 104a-n are properly synchronized with the GNSS clock.

In embodiments, the gateway device(s) 104a-n (e.g., the MCU 120) determines (e.g., calculates) the beacon send time. The gateway device(s) 104a-n (e.g., the MCU 120) can determine (e.g., calculates) the beacon send time based on determining that the gateway device(s) 104a-n are properly synchronized with the GNSS clock. The gateway device(s) 104a-n (e.g., the MCU 120) can determine the beacon send time by adding the first predetermined amount of time (e.g., two seconds) to the estimated time of occurrence of the edge of the second PPS signal at which the message was sent occurred. For example, if the gateway device(s) 104a-n (e.g., the MCU 120) determined that the edge of the second PPS signal occurred 500 milliseconds before the message receipt time indicated by the timestamp, the gateway device(s) 104a-n (e.g., the MCU 120) can determine that the beacon send time is 1.5 seconds after the message receipt time indicated by the timestamp. The beacon send time can correspond to the positive edge of the first PPS signal (e.g., PPS signal 302c).

In embodiments, the gateway device(s) 104a-n schedule the sending of the next beacon to the end device(s) 102a-n. The gateway device(s) 104a-n can schedule the sending of the next beacon to happen at the determined beacon send time. The MCU 120 can send the calculated beacon send time to the concentrator component 118. The concentrator component 118 can receive the calculated beacon send time. The concentrator component 118 can schedule the sending of a next time-synchronized beacon to the end device(s) 102a-n. The next time-synchronized beacon can be scheduled to be sent to the end device(s) 102a-n at the calculated beacon send time. The concentrator component 118 can send (e.g., issue) the next time-synchronized beacon to the end device(s) 102a-n at the scheduled beacon send time.

In embodiments, the gateway device(s) 104a-n (e.g., the MCU 120) can send a confirmation message back to the relay device 107 (e.g., the MCU 112) in response to receiving the message from the relay device 107. The confirmation message can indicate that the gateway device(s) 104a-n received the message. The confirmation message can indicate the time at which the gateway device(s) 104a-n received the message. The relay device 107 can receive the confirmation message. The relay device 107 can use the message to determine the actual amount of time that lapsed in between the relay device 107 sending the message and the gateway device(s) 104a-n receiving the message. The relay device 107 can send a response message back to the gateway device(s) 104a-n. The response message can indicate the actual amount of time that lapsed in between the relay device 107 sending the message and the gateway device(s) 104a-n receiving the message. The gateway device(s) 104a-n can update the predetermined amount of send time based on the response message. For example, the gateway device(s) 104a-n can update the predetermined amount of send time based on the actual amount of time that lapsed in between the relay device 107 sending the message and the gateway device(s) 104a-n receiving the message. This process can be performed once (i.e., to determine the predetermined amount of send time), or can be repeated periodically to ensure that the predetermined amount of send time is accurate.

Thus, using the techniques described above, the relay device 107 enables a gateway device to support communication that requires strict time synchronization without the gateway device needing to have direct exposure to Satellite constellations. For example, the relay device 107 enables the gateway device to be placed indoors where satellite visibility is often times limited. The time synchronization techniques described herein also do not depend on the gateway device(s) 104a-n being able to establish and/or maintain a low-latency Internet connection. Accordingly, the time synchronization techniques described herein can be especially beneficial in scenarios where cellular serves as the backhaul to the Internet, as ensuring a consistently low-latency connection in such scenarios can be challenging.

While the techniques above are described as facilitating GNSS time synchronization of gateway devices, it should be appreciated that the techniques described herein can additionally, or alternatively, be used to facilitate GNSS time synchronization of end devices. For example, the techniques described herein can additionally, or alternatively, be used to facilitate GNSS time synchronization of one or more of the end device(s) 102a-n. To facilitate GNSS time synchronization of an end device, the relay device 107 can send the SYNC message to the end device. The end device can receive the SYNC message. Using the same techniques described above with regard to the gateway device(s) 104a-n, the end device can determine whether the end device is properly synchronized with the GNSS clock based on the receive time associated with the SYNC message.

While the techniques described herein relate to the use of the relay device 107 for facilitating GNSS time synchronization of the gateway device(s) 104a-n, it should be appreciated that, if the gateway device(s) 104a-n are capable of receiving a GNSS signal, the gateway device(s) 104a-n can instead perform any, or all, of the steps that are described herein as being performed by the relay device 107. For example, the gateway device(s) 104a-n can perform all of the steps that are described herein as being performed by the relay device 107 to achieve GNSS time synchronization, thereby enabling the enabling the gateway device(s) 104a-n to generate and manage GNSS time synchronization signals independently. Alternatively, the gateway device(s) 104a-n can perform some of the steps necessary to achieve GNSS time synchronization, with the relay device 107 performing the remaining steps necessary to facilitate GNSS time synchronization of the gateway device(s) 104a-n.

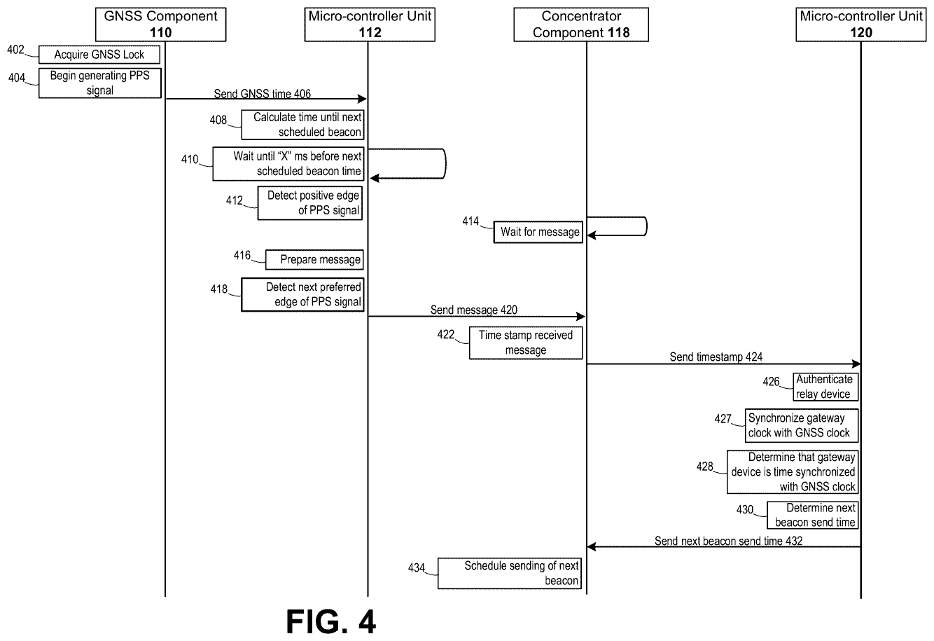

FIG. 4 is an example process 400 for facilitating GNSS time synchronization of gateway devices. As described above, the relay device 107 can associate itself with the network 100. In embodiments, the relay device 107 can associate itself with the network 100 using Over-The-Air Activation (OTAA). In other embodiments, the relay device 107 can associate itself with the network 100 without joining the network 100.

At 402, the GNSS component 110 attempts to acquire a GNSS lock. The GNSS component 110 can attempt to acquire the GNSS lock based on (e.g., in response to) determining that the relay device 107 has associated itself with the network 100. The GNSS component 110 can attempt to acquire a GNSS lock by attempting to initiate a connection with the GNSS satellite(s) 113a-n. If the GNSS component 110 successfully acquires a GNSS lock, the GNSS component 110 can begin generating a plurality of pulse per second (PPS) signals. At 404, the GNSS component 110 begins generating a plurality of PPS signals. The plurality of PPS signals is time synchronized with the GNSS clock.

At 406, the GNSS component 110 sends an indication of a current time associated with the GNSS clock to the MCU 112. The MCU 112 can receive the indication of the current time associated with the GNSS clock from the GNSS component 110. At 408, the MCU 112 can determine an amount of time before the gateway device(s) 104a-n are next scheduled to send a beacon to the end device(s) 102a-n. For example, the MCU 112 can determine that the beacon send time is four seconds (or any other number of milliseconds and/or seconds) after the current time associated with the GNSS clock. The amount of time before the gateway device(s) 104a-n are next scheduled to send a beacon to the end device(s) 102a-n corresponds to the quantity K of PPS signals that are to occur in between the current time associated with the GNSS clock and the beacon send time.

At 410, the MCU 112 can wait until the current time is equal to a quantity X of seconds and/or milliseconds before the beacon send time. The quantity X of second and/or milliseconds may comprise a number of second and/or milliseconds that is large enough to allow both for the preparation of a message (e.g., SYNC message) and the sending of the message to the gateway device(s) 104a-n the first predetermined amount of time before the beacon send time. For example, if the first predetermined amount of time comprises two seconds, the quantity X of milliseconds may comprise three seconds. Thus, the MCU 112 can wait until the current time is equal to a 3 seconds before the beacon send time. At 412, the MCU 112 can detect an edge (e.g., positive edge or negative edge) of a PPS signal of the plurality of PPS signals. At 414, the concentrator component 118 can wait to receive the message from the MCU 112.

At 416, the MCU 112 prepares the message. The MCU 112 can prepare the message based on detecting the edge (e.g., positive edge or negative edge) of the PPS signal. As described above, the message can comprise an encrypted SYNC message. The message comprises data indicating that the message is a SYNC message. For example, the message can include data identifying the message as a proprietary SYNC message. The message can further include data indicating how the transmission time-on-air expectation changes for a particular uplink data rate, such as a particular LoRaWAN uplink data rate. The message can further comprise a device identifier associated with the relay device 107. The message can further comprise dummy data (e.g., some unique sequence of bits). The message can further comprise data indicating the GNSS position (e.g., latitude, longitude) data of the relay device 107.

At 418, the MCU 112 can detect a next preferred edge (e.g., positive edge or negative edge) of the second PPS signal. The next preferred edge of the second PPS signal may occur the first predetermined amount of time (e.g., two seconds) before the beacon send time. At 420, the MCU 112 sends the message to the gateway device(s) 104a-n. The MCU 112 can send the message based on detecting the next preferred edge of the second PPS signal. The MCU 112 can send the message to the gateway device(s) 104a-n using a user selected uplink Port.

The concentrator component 118 can receive the first message. As described above, the first message can comprise data identifying the first message as a proprietary SYNC message. The message can further comprise the time in seconds in which the message was sent and/or any other proprietary data. In response to receiving the first message, the gateway device(s) 104a-n (e.g., the concentrator component 118) can determine that the first message is a SYNC message based on the data included in the first message.

It can take the message a predetermined amount of send time to reach the gateway device(s) 104a-n. The predetermined amount of send time can comprise any number of seconds or milliseconds, such as 200 milliseconds, 300 milliseconds, 400 milliseconds, 500 milliseconds, 600 milliseconds, 700 milliseconds, 800 milliseconds, 900 milliseconds, one second, etc. Thus, while the message was sent by the relay device 107 the first predetermined amount of time (e.g., two seconds) before the beacon send time, the message may not be received by the gateway device(s) 104a-n the first predetermined amount of time before the beacon send time. For example, if the first predetermined amount of time is two seconds, and the predetermined amount of send time is 500 milliseconds, the message can be received by the gateway device(s) 104a-n 1.5 seconds before the beacon send time. The predetermined amount of send time is known to the gateway device(s) 104a-n. The predetermined amount of send time can include the amount of time that it takes to modulate and/or demodulate the message.

In embodiments, there can be an additional delay between the message being sent by the relay device 107 and the message being received by the gateway device(s) 104a-n. Such additional delay can be a variable message transmission delay. The amount of additional delay can be based on the distance between the relay device 107 and the gateway device(s) 104a-n. For example, if the relay device 107 and the gateway device(s) 104a-n are located one mile apart from each other, the additional delay can be a delay of approximately 5.4 microseconds.

The concentrator component 118 can determine a time associated with receipt of the message. The concentrator component 118 can determine the time associated with receipt of the message based on the internal microsecond count of the concentrator component 118. The time can be the time at which the concentrator component 118 received the message. At 422, the concentrator component 118 can, for example, create a timestamp associated with the message. The timestamp can indicate the time at which the concentrator component 118 received the message. At 424, the concentrator component 118 can send the timestamp to the MCU 120.

At 426, the MCU 120 can authenticate the message. The MCU 120 can authenticate the message based on (e.g., in response to) determining that the message is a SYNC message. The MCU 120 can authenticate the message to verify that the message was received from the relay device 107. In embodiments, to authenticate the message, the MCU 120 can verify that the message was received via the user selected uplink Port. To authenticate the message, the MCU 120 can parse the message with a known encryption key. If the MCU 120 determines that the decrypted payload matches what is expected from the relay device 107, the message is authenticated.

The MCU 120 can receive the timestamp. At 427, the MCU 120 can synchronize a clock (e.g., an internal clock) of the gateway device(s) 104a-n with the GNSS clock. The MCU 120 can synchronize the clock of the gateway device(s) 104a-n with the GNSS clock based on the timestamp. For example, the MCU 120 can determine (e.g., estimate) when the next preferred edge of the second PPS signal occurred. As described above, the predetermined amount of send time is known to the gateway device(s) 104a-n. Thus, the MCU 120 can use the timestamp and the predetermined amount of send time to determine (e.g., estimate) when the next preferred edge of the second PPS signal occurred. For example, if the predetermined amount of send time is 500 milliseconds, the MCU 120 can determine that the edge of the next preferred edge of the second PPS signal occurred 500 milliseconds before the message receipt time indicated by the timestamp. The MCU 120 can synchronize the internal clock of the gateway device(s) 104a-n with the GNSS clock by determining and applying an offset to its internal clock based on the time difference between its internal clock and the estimated time of occurrence of the edge of the next preferred edge of the second PPS signal. At 428, the MCU 120 can determine that the gateway device(s) 104a-n are properly synchronized with the GNSS clock.

At 430, the MCU 120 determines (e.g., calculates) the beacon send time. The MCU 120 can determine the beacon send time by adding the first predetermined amount of time (e.g., two seconds) to the estimated time of occurrence of the edge of the next preferred edge of the second PPS signal. For example, if the MCU 120 determined that the edge of the next preferred edge of the second PPS signal occurred 500 milliseconds before the message receipt time indicated by the timestamp, the MCU 120 can determine that the beacon send time is 1.5 seconds after the message receipt time indicated by the timestamp. At 432, the MCU 120 sends the calculated beacon send time to the concentrator component 118.

The concentrator component 118 can receive the calculated beacon send time. At 434, the concentrator component 118 can schedule the sending of a next time-synchronized beacon to the end device(s) 102a-n. The next time-synchronized beacon can be scheduled to be sent to the end device(s) 102a-n at the calculated beacon send time. The concentrator component 118 can send (e.g., issue) the next time-synchronized beacon to the end device(s) 102a-n at the scheduled beacon send time.

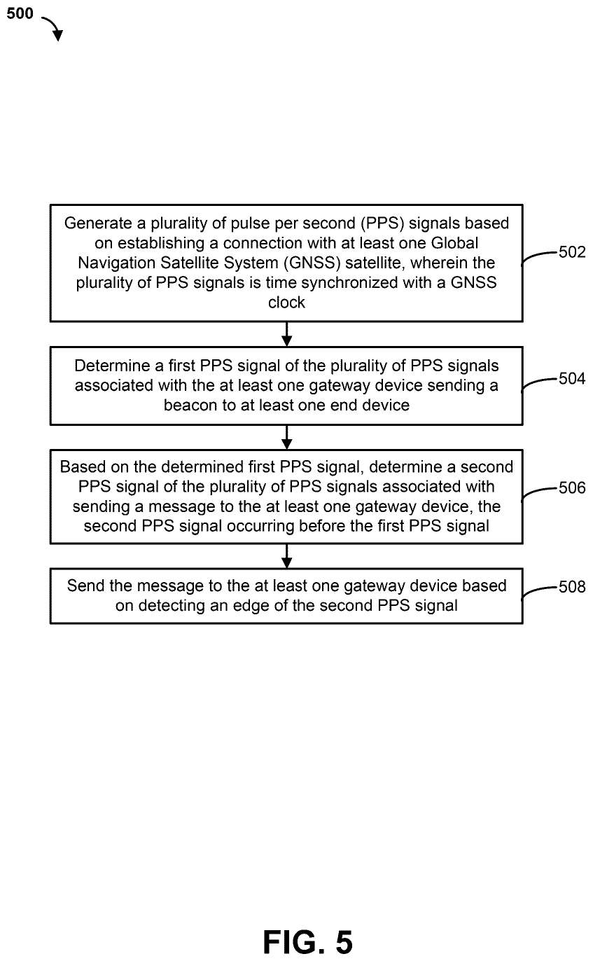

FIG. 5 is a flow diagram illustrating an example method 500. The method 500 may comprise a method for facilitating GNSS time synchronization of gateway devices, such as LoRaWAN gateway devices. The relay device 107 may be configured to perform the method 500.

A relay device (e.g., a GNSS component of a relay device) can attempt to acquire a GNSS lock. The relay device can attempt to acquire the GNSS lock based on (e.g., in response to) determining that the relay device has associated itself with a network, such as the LoRaWAN network. The relay device attempt to acquire a GNSS lock by attempting to initiate a connection with one or more GNSS satellites. The relay device can automatically attempt to acquire a GNSS lock based on (e.g., in response to) being turned on (e.g., powered on). At 502, a plurality of PPS signals is generated. The plurality of PPS signals can be generated based on the relay device establishing a connection with at least one GNSS satellite. The plurality of PPS signals is time synchronized with a GNSS clock.

The relay device can receive an indication of the current time associated with the GNSS clock. The relay device can determine a beacon send time at which at least one gateway device is next scheduled to send a time-synchronized beacon to at least one end device. The gateway device(s) can transmit a time-synchronized beacon every 128 seconds.

At 504, a first PPS signal of the plurality of PPS signals is determined. The first PPS signal can be associated with the gateway device(s) sending a next beacon to the end device(s). For example, the gateway device(s) may be scheduled to send the next beacon to the end device(s) at an edge (e.g., positive edge or negative edge) of the first PPS signal. The first PPS signal can be determined by determining a quantity (“K”) of PPS signals of the plurality of PPS signals that are to occur in between the current time associated with the GNSS clock and the beacon send time. For example, the first PPS signal can be determined by determining the quantity K of PPS signals that are to occur in between the PPS signal associated with the current time and the beacon send time.

At 506, a second PPS signal of the plurality of PPS signals is determined. The second PPS signal is associated with sending a message to the at least one gateway device. The second PPS signal can be determined based on the first PPS signal. The second PPS signal occurs before the first PPS signal. The second PPS signal can be determined by determining that an edge (e.g., positive edge or negative edge) of the second PPS signal occurs a first predetermined amount of time before the edge of the first PPS signal at which the gateway device is scheduled to send the next beacon to the end device(s). The first predetermined amount of time can be, for example, one second, two seconds, three seconds, four seconds, or any other number of seconds or milliseconds.

At 508, the message is sent to the gateway device(s). The message can be sent to the gateway device(s) based on detecting the edge (e.g., positive edge or negative edge) of the second PPS signal. The gateway device(s) are configured to utilize a time associated with receipt of the message at the gateway device(s) to determine that the gateway device(s) are time synchronized with the GNSS clock.

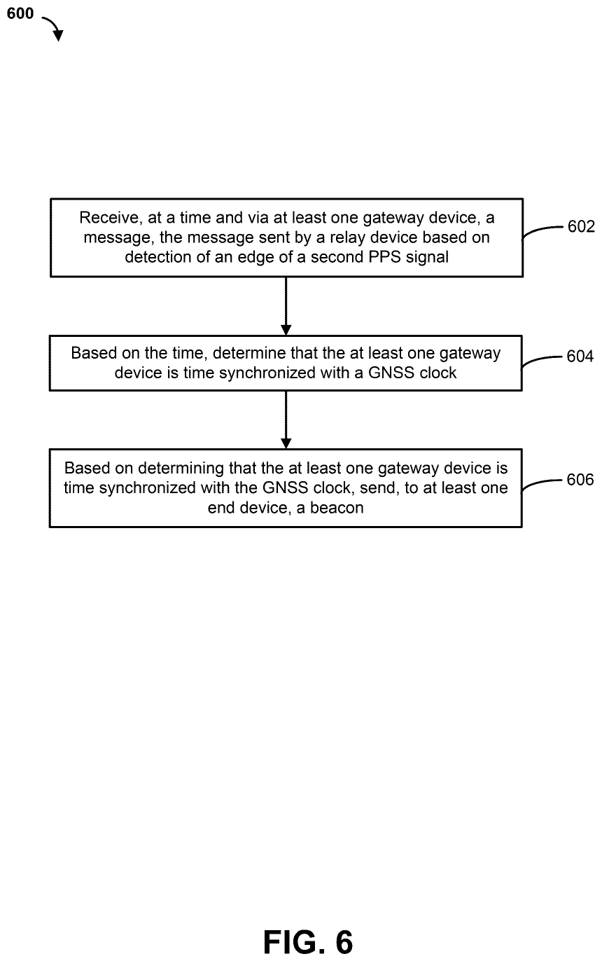

FIG. 6 is a flow diagram illustrating an example method 600. The method 600 may comprise a method for facilitating GNSS time synchronization of gateway devices, such as LoRaWAN gateway devices. One or more of the gateway device(s) 104a-n may be configured to perform the method 600.

At 602, a message is received. The message can be received at a time. The message can be received via at least one gateway device. The message can be received from a relay device. The relay device may have sent the message based on a predetermined amount of time elapsing since an edge (e.g., positive edge or negative edge) of a second PPS signal generated by the relay device. The message can comprise data identifying the message as a proprietary SYNC message. In response to receiving the message, it can be determined that the message is a SYNC message based on (e.g., using) the data included in the message.

At 604, it is determined that the at least one gateway device is time synchronized with a GNSS clock. It can be determined that the at least one gateway device is time synchronized with a GNSS clock based on the time at which the message was received. For example, it can be determined that the at least one gateway device is time synchronized with a GNSS clock by determining (e.g., estimating) when the edge of the second PPS signal occurred. It may be determined when the edge of the second PPS signal occurred using the time at which the message was received and the predetermined amount of send time (e.g., the amount of time it took the message to reach the at least one gateway device after being sent by the relay device). For example, if the predetermined amount of send time is 500 milliseconds, it can be determined that the edge of the second PPS signal occurred 500 milliseconds before the message receipt time.

A next beacon send time can be determined (e.g., calculated). The next beacon send time can be determined by adding the first predetermined amount of time (e.g., two seconds) to the estimated time of occurrence of the edge of the second PPS signal. For example, if the edge of the second PPS signal is estimated to have occurred 500 milliseconds before the message receipt time, it can be determined that the next beacon send time is 1.5 seconds after the message receipt time. The sending of the next beacon to the end device(s) can be scheduled. The sending of the next beacon to the end device(s) can be scheduled to happen at the determined next beacon send time. At 606, a beacon is sent to at least one end device. The beacon can be sent to the at least one end device based on (e.g., in response to) determining that the at least one gateway device is time synchronized with the GNSS clock. The beacon can be sent at the scheduled beacon send time.

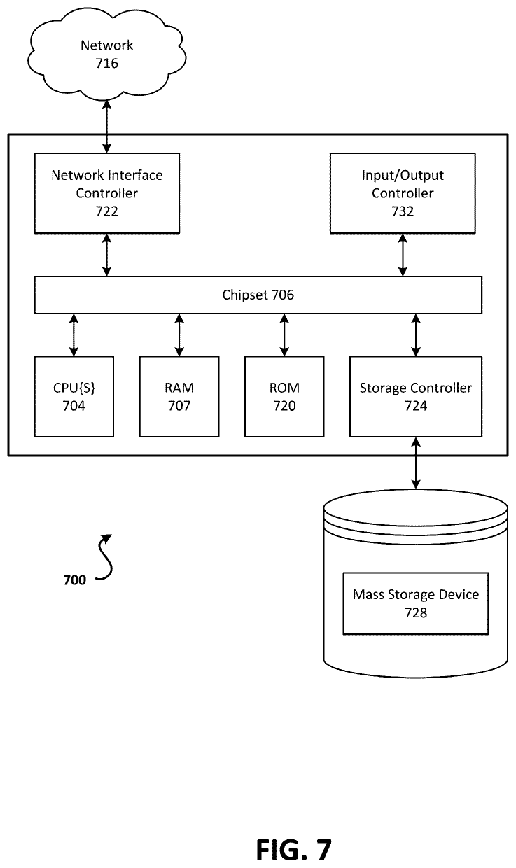

FIG. 7 depicts a computing device that may be used in various aspects, such as the servers and/or devices depicted in FIG. 1. With regard to the example architecture of FIG. 1, the end device(s) 102a-n, the gateway device(s) 104a-n, the relay device 107, the network server device 106, and/or the application server device(s) 108a-n may each be implemented in an instance of a computing device 700 of FIG. 7.

The computer architecture shown in FIG. 7 shows a conventional server computer, workstation, desktop computer, laptop, tablet, network appliance, PDA, e-reader, digital cellular phone, or other computing node, and may be utilized to execute any aspects of the computers described herein, such as to implement the methods described in relation to FIG. 5 and FIG. 6.

The computing device 700 may include a baseboard, or “motherboard,” which is a printed circuit board to which a multitude of components or devices may be connected by way of a system bus or other electrical communication paths. One or more central processing units (CPUs) 704 may operate in conjunction with a chipset 706. The CPU(s) 704 may be standard programmable processors that perform arithmetic and logical operations necessary for the operation of the computing device 700.

The CPU(s) 704 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 704 may be augmented with or replaced by other processing units, such as GPU(s) 705. The GPU(s) 705 may comprise processing units specialized for but not necessarily limited to highly parallel computations, such as graphics and other visualization-related processing.

A chipset 706 may provide an interface between the CPU(s) 704 and the remainder of the components and devices on the baseboard. The chipset 706 may provide an interface to a random access memory (RAM) 708 used as the main memory in the computing device 700. The chipset 706 may further provide an interface to a computer-readable storage medium, such as a read-only memory (ROM) 720 or non-volatile RAM (NVRAM) (not shown), for storing basic routines that may help to start up the computing device 700 and to transfer information between the various components and devices. ROM 720 or NVRAM may also store other software components necessary for the operation of the computing device 700 in accordance with the aspects described herein.

The computing device 700 may operate in a networked environment using logical connections to remote computing nodes and computer systems through local area network (LAN) 716. The chipset 706 may include functionality for providing network connectivity through a network interface controller (NIC) 722, such as a gigabit Ethernet adapter. A NIC 722 may be capable of connecting the computing device 700 to other computing nodes over a network 716. It should be appreciated that multiple NICs 722 may be present in the computing device 700, connecting the computing device to other types of networks and remote computer systems.

The computing device 700 may be connected to a mass storage device 728 that provides non-volatile storage for the computer. The mass storage device 728 may store system programs, application programs, other program components, and data, which have been described in greater detail herein. The mass storage device 728 may be connected to the computing device 700 through a storage controller 724 connected to the chipset 706. The mass storage device 728 may consist of one or more physical storage units. A storage controller 724 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 700 may store data on a mass storage device 728 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 728 is characterized as primary or secondary storage and the like.

For example, the computing device 700 may store information to the mass storage device 728 by issuing instructions through a storage controller 724 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 700 may further read information from the mass storage device 728 by detecting the physical states or characteristics of one or more particular locations within the physical storage units.

In addition to the mass storage device 728 described above, the computing device 700 may have access to other computer-readable storage media to store and retrieve information, such as program components, data structures, or other data. It should be appreciated by those skilled in the art that computer-readable storage media may be any available media that provides for the storage of non-transitory data and that may be accessed by the computing device 700.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (EPROM), electrically erasable programmable ROM (EEPROM), flash memory or other solid-state memory technology, compact disc ROM (CD-ROM), digital versatile disk (DVD), high definition DVD (HD-DVD), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 728 depicted in FIG. 7, may store an operating system utilized to control the operation of the computing device 700. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 728 may store other system or application programs and data utilized by the computing device 700.

The mass storage device 728 or other computer-readable storage media may also be encoded with computer-executable instructions, which, when loaded into the computing device 700, transforms the computing device from a general-purpose computing system into a special-purpose computer capable of implementing the aspects described herein. These computer-executable instructions transform the computing device 700 by specifying how the CPU(s) 704 transition between states, as described above. The computing device 700 may have access to computer-readable storage media storing computer-executable instructions, which, when executed by the computing device 700, may perform the methods described in relation to FIG. 5 and FIG. 6.

A computing device, such as the computing device 700 depicted in FIG. 7, may also include an input/output controller 732 for receiving and processing input from a number of input devices, such as a keyboard, a mouse, a touchpad, a touch screen, an electronic stylus, or other type of input device. Similarly, an input/output controller 732 may provide output to a display, such as a computer monitor, a flat-panel display, a digital projector, a printer, a plotter, or other type of output device. It will be appreciated that the computing device 700 may not include all of the components shown in FIG. 7, may include other components that are not explicitly shown in FIG. 7, or may utilize an architecture completely different than that shown in FIG. 7.

As described herein, a computing device may be a physical computing device, such as the computing device 700 of FIG. 7. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described herein with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, or in addition, some or all of the software components and/or systems may execute in memory on another device and communicate with the illustrated computing systems via inter-computer communication. Furthermore, in some embodiments, some or all of the systems and/or components may be implemented or provided in other ways, such as at least partially in firmware and/or hardware, including, but not limited to, one or more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the components, systems, and data structures may also be stored (e.g., as software instructions or structured data) on a computer-readable medium, such as a hard disk, a memory, a network, or a portable media article to be read by an appropriate device or via an appropriate connection. The systems, components, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A system comprising:
at least one gateway device; and
a relay device in communication with the at least one gateway device, wherein the relay device is configured to:
generate, via a Global Navigation Satellite System (GNSS) component, a plurality of pulse per second (PPS) signals based on establishing a connection with at least one GNSS satellite, wherein the plurality of PPS signals is time synchronized with a GNSS clock;
determine a first PPS signal of the plurality of PPS signals associated with the at least one gateway device sending a beacon to at least one end device;
based on the determined first PPS signal, determine a second PPS signal of the plurality of PPS signals associated with sending a message to the at least one gateway device, the second PPS signal occurring before the first PPS signal; and
send the message to the at least one gateway device based on detecting an edge of the second PPS signal,
wherein the at least one gateway device is configured to utilize a time associated with receipt of the message at the at least one gateway device to determine that the at least one gateway device is time synchronized with the GNSS clock.

2. The system of claim 1, wherein the at least one gateway device comprises at least one Long Range Wide Area Network (LoRaWAN) gateway device configured to support end devices operating in a Class B mode of communication.

3. The system of claim 1, wherein the at least one gateway device is not configured to establish a connection with the at least one GNSS satellite.

4. The system of claim 1, wherein the at least one gateway device is further configured to send the beacon to the at least one end device based on determining that the at least one gateway device is time synchronized with the GNSS clock.

5. The system of claim 1, wherein the relay device is further configured to:
based on the determined second PPS signal, determine a third PPS signal associated with preparing the message, the third PPS signal occurring before the second PPS signal; and
prepare the message based on detecting an edge of the third PPS signal.

6. The system of claim 1, wherein the relay device is further configured to:
prepare the message based on detecting a positive edge of the second PPS signal, and wherein the relay device is configured to send the message to the at least one gateway device based on detecting a negative edge of the second PPS signal.

7. The system claim 1, wherein the relay device is configured to determine the second PPS signal associated with sending the message to the at least one gateway device by determining that the edge of the second PPS signal occurs a predetermined amount of time before an edge of the first PPS signal.

8. The system of claim 7, wherein the predetermined amount of time is two seconds.

9. The system of claim 1, wherein the relay device is further configured to:
determine a current time associated with the GNSS clock; and
determine a beacon send time at which the at least one gateway device is to send the beacon to the at least one end device.

10. The system of claim 9, wherein the relay device is configured to determine the first PPS signal associated with the at least one gateway device sending the beacon to at least one end device by determining a quantity of PPS signals of the plurality of PPS signals that are to occur in between the current time and the beacon send time.

11. A relay device comprising:
a Global Navigation Satellite System (GNSS) component configured to generate a plurality of pulse per second (PPS) signals based on establishing a connection with at least one GNSS satellite, wherein the plurality of PPS signals are time synchronized with a GNSS clock;
one or more processors; and
memory storing instructions that, when executed by the one or more processors, cause the relay device to:
determine a first PPS signal of the plurality of PPS signals associated with at least one gateway device sending a beacon to at least one end device;
based on the determined first PPS signal, determine a second PPS signal of the plurality of PPS signals associated with sending a message to the at least one gateway device, the second PPS signal occurring before the first PPS signal; and
send the message to the at least one gateway device based on detecting an edge of the second PPS signal,
wherein the at least one gateway device is configured to utilize a time associated with receipt of the message at the at least one gateway device to determine that the at least one gateway device is time synchronized with the GNSS clock.

12. The relay device of claim 11, wherein the at least one gateway device comprises at least one Long Range Wide Area Network (LoRaWAN) gateway device configured to support end devices operating in a Class B mode of communication.

13. The relay device of claim 11, wherein the at least one gateway device is not configured to establish a connection with the at least one GNSS satellite.

14. The relay device of claim 11, wherein the memory storing instructions that, when executed by the one or more processors, further cause the relay device to:
based on the determined second PPS signal, determine a third PPS signal associated with preparing the message, the third PPS signal occurring before the second PPS signal; and
prepare the message based on detecting an edge of the third PPS signal.

15. The relay device of claim 11, wherein the memory storing instructions that, when executed by the one or more processors, further cause the relay device to:
prepare the message based on detecting a positive edge of the second PPS signal, and wherein the relay device is configured to send the message to the at least one gateway device based on detecting a negative edge of the second PPS signal.

16. The relay device of claim 11, wherein the relay device is configured to determine the second PPS signal associated with sending the message to the at least one gateway device by determining that the edge of the second PPS signal occurs a predetermined amount of time before an edge of the first PPS signal.

17. The relay device of claim 16, wherein the predetermined amount of time is two seconds.

18. The relay device of claim 11, wherein the memory storing instructions that, when executed by the one or more processors, further cause the relay device to:
determine a current time associated with the GNSS clock; and
determine a beacon send time at which the at least one gateway device is to send the beacon to the at least one end device; and wherein the relay device is configured to determine the first PPS signal associated with the at least one gateway device sending the beacon to at least one end device by determining a quantity of PPS signals of the plurality of PPS signals that are to occur in between the current time and the beacon send time.

19. A method comprising:
generating, via a Global Navigation Satellite System (GNSS) component, a plurality of pulse per second (PPS) signals based on establishing a connection with at least one GNSS satellite, wherein the plurality of PPS signals are time synchronized with a GNSS clock;
determining a first PPS signal of the plurality of PPS signals associated with the at least one gateway device sending a beacon to at least one end device;
based on the determined first PPS signal, determining a second PPS signal of the plurality of PPS signals associated with sending a message to the at least one gateway device, the second PPS signal occurring before the first PPS signal; and
sending the message to the at least one gateway device based on detecting an edge of the second PPS signal,
wherein the at least one gateway device is configured to utilize a time associated with receipt of the message at the at least one gateway device to determine that the at least one gateway device is time synchronized with the GNSS clock.

20. The method of claim 19, wherein the at least one gateway device comprises at least one Long Range Wide Area Network (LoRaWAN) gateway device configured to support end devices operating in a Class B mode of communication.
